(19) United States
(12) Patent Application Publication
(10) Pub. No.: US 2023/0405605 A1
(43) Pub. Date: Dec. 21, 2023

(54) SCREW HUB, CENTRIFUGAL SCREW, AND SOLID BOWL SCREW CENTRIFUGE

(71) Applicant: FLOTTWEG SE, Vilsbiburg (DE)

(72) Inventors: Benno Vielhuber, Vilsbiburg (DE); Lothar Fränkel, Gerzen (DE); Manfred Schlarb, Vilsbiburg (DE); Andreas Karolis, Vilsbiburg (DE)

(21) Appl. No.: 18/035,440

(22) PCT Filed: Nov. 9, 2021
(86) PCT No.: PCT/EP2021/081075

§ 371 Date: May 4, 2023

(30) Foreign Application Priority Data
Nov. 9, 2020 (DE) 10 2020 129 481.6

(51) Int. Cl. B04B 1/20

(52) U.S. Cl. CPC B04B 1/20; B04B 2001/2058; B04B 2001/205

(57) ABSTRACT

The invention relates to a screw hub (10) for a centrifugal screw (80), said screw hub (10) having, in the longitudinal direction (R), at least one cylindrical longitudinal portion (11) and a portion (12) at the solid-discharge end, the cylindrical longitudinal portion (11) having an open wall structure (40), and the portion (2) at the solid-discharge end having an at least partly closed shape that differs from a simple conical shape.

The invention relates to a screw hub for a centrifugal screw, according to claim 1. Furthermore, the invention relates to a centrifugal screw according to claim 9. In addition, the invention relates to a solid bowl screw centrifuge according to claim 10.

Solid bowl screw centrifuges are characterized by a drum having a closed or solid envelope. The drum is rotated at a high rotational speed, whereby a multiphase mixture located within the drum can be separated into a heavy phase and a light phase. The heavy phase usually is a solid phase transported out of the drum by a screw, i.e. a centrifugal screw. For this purpose, the screw is mounted within the drum to be rotatable relative to the drum and has a screw spiral. The screw spiral is arranged around a screw hub.

The screw spiral swipes along the inner side or the inner envelope surface of the drum and thus conveys the product of the heavy phase to an axial end area of the drum. At the end of the drum, the product of the heavy phase is conveyed out from the drum. The multiphase mixture to be clarified hence is located between the inner side of the drum and the screw hub.

In certain solid bowl screw centrifuges, a large pond depth is aspired in particular for clarification reasons. At the same time, however, the pond depth is limited by the diameter of the screw hub and buoyancy and deposition effects of the mixture to be clarified or the light phase.

In a widespread form of the centrifugal screw, a portion at the solid-discharge end of the screw hub is formed by a simple cone shape. The cone is designed, for example, as a closed envelope surface.

Such a shape of a portion at the solid-discharge end of the screw hub, however is not advantageous for all fields of application or products to be processed. Due to such a shape, the portion at the solid-discharge end, blockages partly occur in the area of the solid material discharge.

Moreover, the state of the solid material discharge is clump-shaped, for example.

The invention is therefore based on the task of providing a screw hub for a centrifugal screw, which has both improved flow properties and improved properties in conjunction with a solid material discharge due to an improved constructional assembly.

Furthermore, the invention is based on the task of proposing a further developed centrifugal screw and a further developed solid bowl screw centrifuge.

According to the invention, this task is solved with respect to the screw hub by the subject matter of claim 1. With respect to the centrifugal screw, the task mentioned before is solved by the subject matter of claim 9, and with respect to the solid bowl screw centrifuge by the subject matter of claim 10.

The subclaims comprise at least appropriate configurations and further developments.

Specifically, the task is solved by a screw hub for a centrifugal screw, wherein the screw hub has at least one cylindrical longitudinal portion and a portion at the solid-discharge end in the longitudinal direction. The cylindrical longitudinal portion of the screw hub has an open wall structure at least in sections, and the portion at the solid-discharge end has an at least partly closed shape deviating from a simple cone shape.

The longitudinal direction of the screw hub is essentially defined by the longitudinal axis of a screw hub. The longitudinal axis of a screw hub is the axis around which the screw hub rotates when being used.

The longitudinal direction is preferably defined as being the direction of transport of the solid matter discharge.

In the longitudinal direction of the screw hub, the screw hub according to the invention has at least two different portions. One portion is the cylindrical longitudinal portion. A further portion is the portion at the solid-discharge end. The mentioned two portions form the main portions of the screw hub. The screw hub may additionally comprise bearing portions in particular at the end portions or the ends of the screw hub. The bearing portions, however, may also be formed as partial portions of the mentioned main portions or protrude into these main portions.

The portion at the solid-discharge end preferably forms at least one end of the screw hub.

In order to cause in different fields of application or in cases of materials to be differently processed, an improved discharge of solid matter and thus a correspondingly improved state of the solid matter discharge, the portion at the solid-discharge end has an at least partially closed shape deviating from a simple cone shape.

Such a shape must be designated to be a simple cone shape which has a truncated cone shape in a longitudinal section through the screw hub. The truncated cone shape is formed due to a closed envelope surface.

It is possible that the cylindrical longitudinal portion forms in particular a/the further end of the screw hub and/or comprises in particular a/the further end of the screw hub.

A/the further end of the screw hub, for example, may be designed such that it forms a bearing portion for being fixed in a drum of a solid bowl screw centrifuge.

It is furthermore possible that the screw hub has such a bearing portion in the area of the cylindrical longitudinal portion.

A wall structure of this kind is in particular to be understood to be an open wall structure which has a high number of openings in the corresponding portion of the cylindrical longitudinal portion and/or a large opening surface as a whole. In particular, the sum of all single opening surfaces of single openings in the corresponding portion are to be understood as the opening surface. In other words, the opening surface does not have to be a coherent single opening surface.

Preferably, the value of the opening surface is greater than the value of the closed surface. The proportion of the wall structure is to be understood to be a closed surface which is closed and does not enable a material passage from the screw hub interior to the outside (or vice versa). Further preferably, in particular the sum of all single closed surfaces in the corresponding portion has to be understood to be the closed surface.

Furthermore and/or additionally, such a wall structure of the screw hub has to understood as an open wall structure which has a high proportion of openings in the radial direction. Preferably, the proportion of openings is higher than the proportion of closed surfaces. Preferably, the proportion of openings in the radial direction of the screw hub is at least 50%, further preferably at least 60%, particularly preferred at least 65% of the entire wall structure in the radial direction.

Particularly preferred, the described proportion of openings in the radial direction is formed all throughout the entire longitudinal extension of the wall structure.

In a particularly preferred embodiment of the invention, the cylindrical longitudinal portion consists of an open wall structure. In other words, the cylindrical longitudinal portion consists entirely of an open wall structure.

Preferably, the portion at the solid-discharge end completely has a closed shape. As an at least partially closed shape of the portion at the solid-discharge end, such a shape has to be understood which is formed so as to be substantially closed. In particular, as an at least partially closed shape of the portion at the solid-discharge end, does not have to be understood which consists merely of a rod construction, in particular merely of a longitudinal rod construction.

It is possible that the portion at the solid-discharge end is designed as a cylinder portion and/or cylindrical tube portion. In particular such a portion has to be understood to be such a cylinder portion and/or cylindrical tube portion which has a tube, wherein the tube, for example, is attached to the cylindrical longitudinal portion by means of a connecting flange. Such a cylinder portion is designated in the following as a tube which is designed to be hollow at least in sections.

By means of such a realization of the portion of the screw hub at the solid-discharge end, such a screw hub and thus such a centrifugal screw may be provided which contributes in a particularly advantageous manner in reducing bottlenecks in the direction of the solid material discharge. Such bottlenecks are known in a solid bowl screw centrifuge. These are known in the area of the transition of a cylindrical longitudinal portion to a discharging portion.

The drum of a solid bowl screw centrifuge in most cases has a cone shape in this portion. By designing a cylinder portion and/or cylindrical tube portion, an increased volume is provided in the area of the solid material discharge or in the area of the last dwelling path of the solid material in the area of the drum. This thus results in reducing known bottlenecks. Due to that, high solid material freights may be transported during processing of a material or medium to be separated in a certain temporal specification.

A further advantage in designing the portion at the solid-discharge end as a cylinder portion and/or cylindrical tube portion is that the solid material is present in a relaxed shape. This also applies to such a solid material that has possibly already been compressed during processing. Such a relaxed solid material forms in rarer cases clumps at the solid material discharge and is present in a free-flowing shape.

Due to the reduced forces acting upon the portion at the solid-discharge end, such an embodiment is particularly low-wear. Realizing a cylindrical tube portion as the portion at the solid-discharge end is suitable in processing slurries having a high mineral proportion. Also, the processing of wearing media may be performed in a particularly careful manner with such an embodiment of the portion at the solid-discharge end.

Since the screw hub has a cylindrical longitudinal portion in addition which has an open wall structure at least in sections, preferably completely, the screw hub can immerge in a pond of the mixture circulating within the drum and to be clarified, wherein no disadvantageous effects due to buoyancy forces are generated during the immersion.

Moreover, no sedimented particles descending from the mixture to be clarified in the direction of the drum inner side adhere on the longitudinal portion of the screw hub. The sediments particles rather flow off into the outer area of the drum.

By means of the screw hub according to the invention, a large pond depth may be constructed in conjunction with a solid bowl screw centrifuge, wherein improvements in the field of the solid material discharge are achieved at the same time.

It is possible that the cylinder portion and/or the cylindrical tube portion is formed to be stepped such that the cylinder portion and/or the cylindrical tube portion in the longitudinal direction of the screw hub have/has at least two portions having different diameters.

By means of such a step shape, an again improved reduction with respect to the undesired generation of bottlenecks can be achieved. At the same time, the solid material to be transported and discharged may also be further relaxed.

The at least two portions of the cylinder portion and/or the cylindrical tube portion preferably are arranged such that the portion having a minor or minimum diameter is designed to be spaced further from the cylindrical longitudinal portion than the section of the cylinder portion and/or of the cylindrical tube portion having a major or maximum diameter. The step-shaped realization of the cylinder portion and/or the cylindrical tube portion preferably extends such that the diameters of the portion are reduced in a step-wise manner in the direction of the frontal side of the screw hub associated to the portion at the solid-discharge end.

It is possible in a further embodiment of the invention that the portion at the solid-discharge end has a double truncated cone shape. The double truncated cone shape preferably is designed such that the imaginary surface areas of two truncated cones lie next to each other.

The double truncated cone shape preferably is designed such that the maximum diameter of the double truncated cone shape neither is formed at a connecting portion to the cylindrical longitudinal portion nor at a frontal side of the screw hub associated to the portion at the solid-discharge end.

A first cover surface of a first truncated cone of the double truncated cone shape is arranged in a connecting portion and/or a transition area to the cylindrical longitudinal portion of the screw hub.

A second cover surface at the second truncated cone of the double truncated cone shape is formed at the frontal side associated to the portion at the solid-discharge end or pointing into the direction of said frontal side.

It is possible for the truncated cones forming the double truncated cone shape to have the same height. In such an embodiment of the invention, the double truncated cone shape is designed to be axially symmetric. The axis of symmetry is formed in the area of the superimposed surface areas of the two truncated cones.

In a further embodiment of the invention, the truncated cones forming the double truncated cone shape have different heights. The truncated cone being designed adjacent to the cylindrical portion preferably has a lower height than the second truncated cone pointing into the direction of the frontal side of the screw hub.

By means of designing the portion at the solid-discharge end in the form of a double truncated cone, fine substances of materials to be processed and already separated phase-wise, may be better separated again.

Designing a double truncated cone as the portion at the solid-discharge end is particularly suitable in processing materials having a high organic proportion.

Due to designing the double truncated cone shape, centrifugal screws of that kind can in addition be designed which have a lower screw spiral height and/or a lower baffle plate height. In this respect, material may thus be saved in conjunction with the screw spiral and in conjunction with the baffle plates to be possibly designed.

In addition, the mentioned components of a centrifugal screw of a solid bowl screw centrifuge, i.e., a screw spiral and/or a baffle plate, are less stressed than it is the case with designing simple cone shapes in the area of the portion at the solid-discharge end.

When a screw hub having a double truncated cone shape in the area of the portion at the solid-discharge end is designed, a more calm and stable operating behaviour of a corresponding solid bowl screw centrifuge can be noticed.

Due to designing a double truncated cone shape, the distance between the screw and the drum of the solid bowl screw centrifuge is reduced. This presses the solid material, for example, against a baffle plate and increases a pressing effect. Separated liquid, in particular separated water, can flow off unpressurized along the screw due to this construction.

In an embodiment of the invention, the open wall structure is formed at least in sections by longitudinal rods. Such longitudinal rods may be stabilized, for example, by means of transverse discs. Between the longitudinal rods, an opening structure having a plurality of openings for the passage of a medium to be processed is designed. An interior space of the longitudinal portion is formed which is kept free from disturbing objects, wherein the flow properties in the area of the cylindrical longitudinal portion are improved.

The same advantages are achieved in such an embodiment of an open wall structure which is formed at least in sections by a plurality of web elements delimiting a plurality of openings. The web elements, relative to a longitudinal axis, are arranged to be radially outside on the cylindrical longitudinal portion and form a circumference of the longitudinal portion, wherein two web elements each form a web pair delimiting at least one opening, wherein the two web elements of the web pair extend in the longitudinal direction and transversely to the longitudinal direction, or a first web element of the web pair respectively extends in the longitudinal direction, and a second web element of the web pair extends transversely to the longitudinal direction.

Within the scope of the invention, the longitudinal direction corresponds to a direction in parallel to the longitudinal axis of the screw hub. The direction transversely to the longitudinal direction or the transverse direction has to be understood as being a direction along the circumference of the longitudinal portion transversely to the longitudinal axis of the screw hub.

By the longitudinal and/or transverse extension of the web elements of the open wall structure, the cylindrical longitudinal portion and thus the screw hub has increased torsion and bending rigidity. This is particularly advantageous when the screw hub is used in a solid bowl screw centrifuge having a large longitudinal extension, since the entire system thereby has an increased rigidity.

Designing the open wall structure with longitudinal rods has the advantage that it is in this case a form of an open wall structure to be simply produced. Longitudinal rods to be used are components to be simply produced and provided, which in addition can be positioned and fixed relative to one another in a simple manner. Moreover, such an embodiment of an open wall structure is particularly low-wear. If the longitudinal rods are formed of round rods, grinding processes are avoided in an advantageous manner even when abrasive materials are processed.

In a further embodiment of the invention, the open wall structure is formed at least in sections by a tube, in which a plurality of openings is designed for the passage of a medium, wherein the openings each have a longitudinal extension which is preferably greater than a width of the respective openings.

Such an embodiment of an open wall structure has the advantage that it is producible simply and in a cost-effective manner. Essentially, the openings in the tube wall may be formed by mechanical processing. Alternatively, the openings may be formed by laser cutting. In this case, it is advantageous that a welding effort is considerably reduced during the production and the screw hub has an extremely high stability.

Due to this embodiment of a screw hub, a large and continuous supporting surface, for example, for a screw spiral to be fixed, is provided. Hereby, an automatization of subsequent working steps in producing the screw or the centrifugal screw is enabled.

The openings, for example, may have a parallelogram-like shape. Moreover, it is possible for the openings to be formed so as to be distributed in the circumferential direction in a spiral-shape or helix-shape.

Furthermore, it is possible for the cylindrical longitudinal portion of the screw hub to be designed in one piece. Due to a one-piece realization, only low tensions will occur. Moreover, the concentricity of the screw hub is improved due to further unnecessary processing steps.

A further subordinate aspect of the invention relates to a centrifugal screw having a screw hub according to the invention and a screw spiral surrounding the screw hub.

The screw spiral preferably is arranged at the screw hub to be circumferential. The screw spiral is preferably formed over almost the entire or the entire longitudinal extension of the screw hub.

In other words, the screw spiral preferably is arranged both at the cylindrical longitudinal portion of the screw hub and the portion at the solid-discharge end of the screw hub.

A further subordinate aspect of the invention relates to a solid bowl screw centrifuge comprising a centrifugal screw located within a drum, wherein the screw hub of the centrifugal screw is designed according to the invention.

With respect to the centrifugal screw and the solid bowl screw centrifuge, reference is made to the advantages discussed in conjunction with the screw hub.

Moreover, the centrifugal screw or the solid bowl screw centrifuge may have alternatively or additionally single features or a combination of several features mentioned before with respect to the screw hub.

The invention will be explained in more detail below while referring to the attached drawings.

The illustrated embodiments represent examples how the screw hub according to the invention and/or the centrifugal screw according to the invention may be designed.

In these are shown:

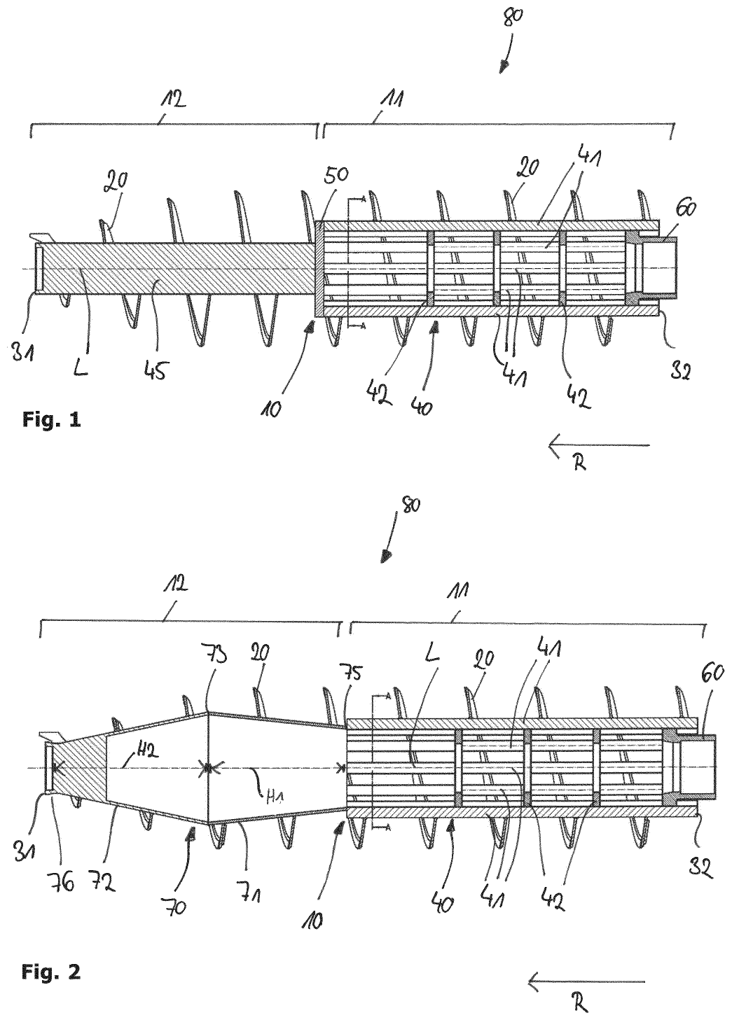

FIG. 1 a longitudinal cut through a centrifugal screw having a screw hub according to the invention according to a first exemplary embodiment; and

FIG. 2 a longitudinal cut through a centrifugal screw having a screw hub according to the invention according to a further exemplary embodiment according to the invention.

In the following, the same reference numerals will be used for equal part or parts having the same action.

In FIG. 1, a centrifugal screw 80 according to the invention having a screw hub 10 according to the invention is presented. The screw hub has a cylindrical longitudinal portion 11 and a portion 12 at the solid-discharge end in the longitudinal direction R.

The longitudinal direction R essentially extends in parallel to the longitudinal axis L of the screw hub 10. In the present case, the longitudinal direction R is defined as the direction of transport of the solid material discharge. According to the illustration of FIG. 1, the solid material transport is performed up to the solid material discharge from the right to the left side.

The screw hub 10 of the centrifugal screw 80 is constituted by all of the illustrated portions and components except for the screw spiral 20. The screw spiral 20 cannot be designed or defined as being associated to the screw hub 10. The screw spiral 20 is to be defined as being a part of the centrifugal screw 80.

In the present case, the longitudinal portion 11 is designed to be longer than the portion 12 at the solid-discharge end.

The illustration of the portion 12 at the solid-discharge end makes clear that this portion does not only relate to the first frontal side 31 of the screw hub 10, but rather is to be understood as being a functional portion serving in particular the transport of the solid material separated from the material to be processed into the direction R of the solid material discharge.

The cylindrical longitudinal portion 11 has an open wall structure 40. The open wall structure 40 is formed by several longitudinal rods 41 and transverse discs 42 stabilizing these longitudinal rods 41. The longitudinal rods 41 are arranged to be evenly distributed in equal distances across the circumference of the screw hub 10 in the longitudinal direction R thereof, thus in parallel to the longitudinal axis.

As is explained in the previous description, the open wall structure may also be formed by web elements, specifically web pairs.

Alternatively, it is possible for the open wall structure to be formed by a tube in which a plurality of openings is designed for the passage of a medium.

The cylindrical longitudinal portion 11 extends from a second frontal side 32 of the screw hub 10 up to a connecting disc 50. The connecting disc 50 serves for connecting the cylindrical longitudinal portion 11 to the portion 12 at the solid-discharge end.

The cylindrical longitudinal portion 11 furthermore comprises a bearing portion 60 for supporting the illustrated centrifugal screws 80 in a drum (not illustrated) of a solid bowl screw centrifuge.

In the present case, the portion 12 at the solid-discharge end is designed to be a cylinder portion 45. The cylinder portion is formed by a solid material and has an equal outer diameter across the entire longitudinal extension of the portion 12 at the solid-discharge end.

By means of such a cylinder portion, a particularly low-wear screw hub 10 is formed contributing additionally for relaxing a solid material to be transported in the area of the portion 12 at the solid-discharge end.

It is possible for the portion 12 at the solid-discharge end to be formed by a cylindrical tube portion. In this case, a hollow cylinder would be designed.

According to the exemplary embodiment of FIG. 1, the screw spiral 20 extends over the entire longitudinal extension of the screw hub 10. The screw spiral 20 is arranged both on the cylindrical longitudinal portion 11 and the portion 12 at the solid-discharge end.

In FIG. 2, a further embodiment of a screw hub 10 according to the invention or of a centrifugal screw 80 according to the invention is illustrated. The contrast to the embodiment illustrated in FIG. 1 is related to the portion 12 at the solid-discharge end. The cylindrical longitudinal portion 11 of the screw hub 10 has a design corresponding to the embodiment according to FIG. 1.

The portion 12 at the solid-discharge end has a double truncated cone shape 70. The double truncated cone shape 70 is formed by two truncated cones, i.e., a first truncated cone 71 and a second truncated cone 72.

The first truncated cone 71 is designed to lie next to the cylindrical longitudinal portion or to be connected to it. The second truncated cone 72, however, points into the direction of the first frontal side 31 of the screw hub 10 or comprises the first frontal side 31 of the screw hub 10.

The two truncated cones 71 and 72 are arranged relative to each other such that the respective (imaginary) surface areas in the connecting portion 73 are designed to adjoin each other.

The cover surface 75 of the first truncated cone 71 and the cover surface of the second truncated cone 72, however, point away from each other. The cover surface 75 of the first truncated cone 71 is adjacent to the cylindrical longitudinal portion 11. The cover surface 75 may also be an imaginary cover surface. The first truncated cone 71 may be designed to be open in the direction of the upper side.

The cover surface 76 of the second truncated cone 71, however, is actually formed. It may be designed, for example, to be a part of the first frontal side 31 of the screw hub 10.

In the presently illustrated case, the two truncated coned 71 and 72 have almost the same heights H1 and H2. It is possible for the heights H1 and H2 to be different from each other in alternative embodiments of the invention.

It is likewise possible that a connecting disc is designed between the cylindrical longitudinal portion 11 and the portion 12 at the solid-discharge end. Such a connecting disc 50, for example, is provided according to the embodiment of FIG. 1.

By means of the embodiment of the screw hub 10 illustrated in FIG. 2 it is possible that further installations of a solid bowl screw centrifuge such as, e.g., the baffle plate (not illustrated), are less stressed. Also, the screw spiral 20 is less stressed than it is the case, for example, in simple cone-shaped geometries, due to the formation of the portion 12 at the solid-discharge end.

It should be noted in conclusion that all of the features mentioned in the documents of application and in particular in the dependent claims, despite the formal back reference made to one or several certain claim/s, should receive an autonomous protection singly or in an arbitrary combination.

### LIST OF REFERENCE NUMERALS

10 screw hub
11 cylindrical longitudinal portion
12 portion at the solid-discharge end
20 screw spiral
31 first frontal side of the screw hub
32 second frontal side of the screw hub
40 open wall structure
41 longitudinal rod
42 transverse disc
45 cylinder portion
50 connecting disc
60 bearing portion
70 double truncated cone shape
71 first truncated cone
72 second truncated cone
73 connecting portion
75 cover surface of the first truncated cone
76 cover surface of the second truncated cone
80 centrifugal screw
H1 height of the first truncated cone
H2 height of the second truncated cone
L longitudinal axis
R longitudinal direction

1. A screw hub (10) for a centrifugal screw (80), wherein the screw hub (10) in the longitudinal direction (R) has at least one cylindrical longitudinal portion (11) and a portion (12) at the solid-discharge end,
wherein the cylindrical longitudinal portion (11) at least in sections has an open wall structure (40), and the portion (12) at the solid-discharge end has an at least partially closed shape deviating from a simple cone shape.

2. The screw hub (10) according to claim 1,
characterized in that
the portion (12) at the solid-discharge end is designed to be a cylinder portion (45) and/or a cylindrical tube portion.

3. The screw hub (10) according to claim 2,
characterized in that
the cylinder portion (45) and/or the cylindrical tube portion are designed to be stepped such that the cylinder portion (45) and/or the cylindrical tube portion have/has at least two portions having different diameters in the longitudinal direction (R) of the screw hub (10).

4. The screw hub (10) according to claim 1,
characterized in that
the portion (12) at the solid-discharge end has a double truncated cone shape (70).

5. The screw hub (10) according to claim 1,
characterized in that
the cylindrical longitudinal portion (11) consists of an open wall structure (40).

6. The screw hub (10) according to claim 1,
characterized in that
the open wall structure (40) at least in sections is formed by a plurality of web elements delimiting a plurality of openings, wherein the web elements relative to a longitudinal axis are arranged to be radially outside at the cylindrical longitudinal portion and form a circumference of the longitudinal portion, wherein two web elements each form a web pair delimiting at least one opening, wherein the two web elements of the web pair extend in the longitudinal direction and transversely to the longitudinal direction, or a first web element of the web pair respectively extends in the longitudinal direction, and a second web element of the web pair respectively extends transversely to the longitudinal direction.

7. The screw hub (10) according to claim 1,
characterized in that
the open wall structure (40) at least in sections is formed by a tube in which a plurality of openings is designed for the passage of a medium, wherein the openings each have a longitudinal extension which is larger than the width of the respective opening.

8. The screw hub (10) according to claim 1,
characterized in that
the open wall structure (40) at least in sections is formed by longitudinal rods (41).

9. A centrifugal screw (80) having a screw hub (10) according to claim 1, and a screw spiral (20) surrounding the screw hub (10).

10. A solid bowl screw centrifuge comprising a centrifugal screw located within a drum, wherein the screw hub (10) of the centrifugal screw is designed according to claim 1.
